(19) United States
(12) Patent Application Publication
(10) Pub. No.: US 2010/0013428 A1
(43) Pub. Date: Jan. 21, 2010

(54) APPARATUS FOR CHARGING PORTABLE DEVICES USING SOLAR CELL

(76) Inventor: Hang-Hee Shin, Seoul (KR)

Correspondence Address: Jason Y. Pahng and Associates, LLC, 12178 Bridgend Run, Fairfax, VA, 22030, US

(21) Appl. No.: 11/989,067

(22) PCT Filed: Jul. 21, 2006
(86) PCT No.: PCT/KR2006/002877

§ 371 Date: Sep. 22, 2009

(30) Foreign Application Priority Data
Jul. 21, 2005 (KR) 10-2005-0066175

(51) Int. Cl. H01M 10/46; F21L 4/00

(52) U.S. Cl. 320/101; 362/183

(57) ABSTRACT

Provided is an apparatus for charging a variety of portable devices using external light without an additional power, and more particularly, an apparatus adding a voltage pump function in which a full charge or quick charge is performed by artificial-intellectually recognizing types of portable devices, the state of a residual current of a battery inside the portable devices is sensed, a voltage of the apparatus is boosted and the battery is fully charged. The apparatus includes a microcomputer, a built-in battery charging the power generated in the solar cell, a built-in battery charging pulse width modulation (PWM) unit switching a charging operation into the built-in battery from the solar cell and controlling the size of a voltage (a charge voltage) supplied to the built-in battery, a built-in battery discharging PWM unit controlling (switching) a discharging operation in which the voltage charged in the built-in battery is discharged into the external device and controlling the size of a discharge voltage, a temperature sensor sensing a temperature of the built-in battery, and a voltage input/output unit outputting the voltage discharged from the built-in battery to the external device and having a common connection terminal to which voltage is inputted from the outside, so as to supply an output voltage of an external battery charger to the built-in battery.

### TECHNICAL FIELD

The present invention relates to a solar cell charging apparatus for charging a battery used in a mobile phone, an MP3 player or a digital camera using a solar light, and more particularly, to a solar cell charging apparatus in which a high-efficiency polymer battery is built and is charged using only a solar cell so that a built-in battery can be charged using a solar light even in a place where there is no electricity, to supply a power to an external device and when there is no solar light, the battery can be charged by a voltage supplied from an external battery charger via a common connection terminal.

### BACKGROUND ART

A technique for substituting commercial AC electricity with a natural energy has been continuously studied. In particular, a solar cell is a component for obtaining a power from a natural light (including an artificial light) which may be infinite. The solar cell has been developed to increase efficiency.

In these days, many devices using a solar cell as a power source have been developed. However, most devices using a solar cell as a power source are just low-power electronic devices such as electronic notes, watches, and electronic calculators. The solar cell cannot be used yet for a battery charger requiring a comparatively high power, and a continuative study thereof is needed.

There are some prior arts as an apparatus for charging portable devices using a solar cell. However, the prior arts do not provide a more technical effect of replacing a power with the solar cell in an existing commercial power charger. In particular, although a voltage of a battery for a portable device is reduced by a discharge, if the battery is left alone at the room temperature for a predetermined amount of time, the voltage of the battery is recovered to its original voltage. In this case, in an existing solar cell charger, the voltage of the charger is not supplied to the battery.

In addition, chargers have been produced by being separately designed as an additional voltage/current specification in each external device. Even if chargers have been produced for universal use, there is an inconvenience for a user to select information about a variety of devices.

When there is an external light not suitable for generating a power in a solar cell, the charger cannot faithfully perform the function of the solar cell charging apparatus. There are some chargers having the function of charging a built-in battery of the solar cell charging apparatus from an external charger (not from the solar cell itself). However, in these chargers, a terminal outputted from the solar cell charging apparatus and a terminal inputted to the solar cell charging apparatus from the external charger are separately installed. As a result, the user is confused and production costs and product failure rates are disadvantageous.

### DISCLOSURE OF THE INVENTION

Accordingly, the present inventor has completed a charging apparatus according to the present invention by developing an apparatus for charging portable devices such as mobile phones, MP3 players and digital cameras using a solar cell and by studying the apparatus to add a new useful function to a conventional charging apparatus while solving the problems of the conventional charging apparatus.

The present invention provides an apparatus for charging portable devices using an external light without an additional power, the apparatus adding a voltage pump function in which a full charge or quick charge is performed by recognizing types of portable devices, the state of a residual current of a battery inside the portable devices is sensed, a voltage of the apparatus is boosted and the battery is fully charged.

The present invention also provides a solar cell charging apparatus having a terminal whose voltage is outputted from the solar cell charging apparatus to an external device and a terminal whose voltage is inputted to the solar cell charging apparatus from the external battery charger in common.

According to an aspect of the present invention, there is provided an apparatus for charging portable devices using a solar cell, the apparatus charging a power generated in the solar cell into a battery inside an external device, the apparatus including a microcomputer, a built-in battery charging the power generated in the solar cell, a built-in battery charging pulse width modulation (PWM) unit switching a charging operation into the built-in battery from the solar cell and controlling the magnitude of a voltage (a charge voltage) supplied to the built-in battery, a built-in battery discharging PWM unit switching a discharging operation in which the voltage charged in the built-in battery is discharged into the external device and controlling the magnitude of a discharge voltage, a temperature sensor sensing a temperature of the built-in battery, and a voltage input/output unit outputting the voltage discharged from the built-in battery to the external device and having a common connection terminal to which a voltage is inputted from the outside, so as to supply an output voltage of an external battery charger to the built-in battery.

According to a first feature of the present invention, the microcomputer may include a built-in battery charging PWM controller controlling the built-in battery charging PWM unit by transmitting a PWM signal to the built-in battery charging PWM unit, a built-in battery discharging PWM controller controlling the built-in battery discharging PWM unit by transmitting a PWM signal to the built-in battery discharging PWM unit, and a battery temperature monitoring unit allowing the built-in battery charging PWM unit to stop an operation of the built-in battery charging PWM unit when a temperature of the battery sensed by the temperature sensor is substantially higher than an allowable temperature range.

According to a second feature of the present invention, the microcomputer may include a built-in battery charging PWM controller controlling the built-in battery charging PWM unit by transmitting a PWM signal to the built-in battery charging PWM unit, a built-in battery discharging PWM controller controlling the built-in battery discharging PWM unit by transmitting a PWM signal to the built-in battery discharging PWM unit, and a built-in battery overcharge preventing unit allowing the built-in battery charging PWM unit to stop an operation of the built-in battery charging PWM unit when measured charge voltage and measured charge current of the built-in battery are substantially larger than predetermined reference values.

According to a third feature of the present invention, the microcomputer may include a built-in battery charging PWM controller controlling the built-in battery charging PWM unit by transmitting a PWM signal to the built-in battery charging PWM unit, a built-in battery discharging PWM controller controlling the built-in battery discharging PWM unit by transmitting a PWM signal to the built-in battery discharging PWM unit, and an external device type recognizing unit allowing the built-in battery discharging PWM controller so that the built-in battery discharging PWM unit varies a voltage, by measuring a voltage, a current and an impedance of an external device battery engaged in the connection terminal of the voltage input/output unit and by calculating a discharge voltage and a discharge current suitable for the measured voltage and current of the external device battery.

According to a fourth feature of the present invention, the microcomputer may include a built-in battery charging PWM controller controlling the built-in battery charging PWM unit by transmitting a PWM signal to the built-in battery charging PWM unit, a built-in battery discharging PWM controller controlling the built-in battery discharging PWM unit by transmitting a PWM signal to the built-in battery discharging PWM unit, and a voltage pump functioning unit allowing the built-in battery discharging PWM controller to control the built-in battery discharging PWM unit and to boost a voltage outputted from the voltage input/output unit when a current and a voltage of a load connected to the connection terminal of the voltage input/output unit are measured and the load current is larger than a minimum of a predetermined value and the load voltage is equal to or less than a maximum of a predetermined voltage range.

Meanwhile, in the above construction, the voltage input/output unit may include a first switching member forming a path on which the voltage discharged from the built-in battery is outputted to the outside via the connection terminal, and a second switching member forming a path on which the voltage outputted from the external battery charger is inputted via the connection terminal and the built-in battery is charged by the input voltage.

In addition, the apparatus may further include a light-emitting source emitting light by the discharge voltage of the built-in battery, and a light-emitting unit including a switch for switching on or off the light-emitting source.

### BRIEF DESCRIPTION OF THE DRAWINGS

The above and other aspects and advantages of the present invention will become more apparent by describing in detail an exemplary embodiment thereof with reference to the attached drawings in which:

FIG. 1 illustrates an apparatus for charging portable devices using a solar cell according to an embodiment of the present invention;

FIG. 2 illustrates the appearance of the apparatus illustrated in FIG. 1;

FIG. 3 is a detailed diagram of a microcomputer illustrated in FIG. 1; and

FIG. 4 illustrates an algorithm for explaining the operation of the apparatus illustrated in FIG. 1.

### BEST MODE FOR CARRYING OUT THE INVENTION

The present invention will now be described more fully with reference to the accompanying drawings, in which an exemplary embodiment of the invention is shown.

Referring to FIG. 1, an apparatus for charging portable devices using a solar cell includes a microcomputer 10 controlling all elements, a built-in battery 50 being built in the apparatus and charging the power generated in the solar cell, a solar cell 20 supplying a power to the built-in battery 50, a built-in battery charging pulse width modulation (PWM) unit 30 (hereinafter, referred to as “charging PWM”) switching a charging operation into the built-in battery 50 from the solar cell 20 and controlling the magnitude of a voltage (a charge voltage) supplied to the built-in battery 50, a built-in battery discharging PWM unit 40 (hereinafter, referred to as “discharging PWM”) controlling (switching) a discharging operation in which the voltage charged in the built-in battery 50 is discharged into the external device and controlling the magnitude of a discharge voltage, a temperature sensor 70 sensing a temperature of the built-in battery 50, and a voltage input/output unit 60 outputting the voltage discharged from the built-in battery 50 to the external device and inputting a voltage to the apparatus from an external charger.

The charging PWM 30 and the discharging PWM 40 include switching elements Q1 and Q2 and inductors L1 and L2, respectively. On/off control of the respective switching elements Q1 and Q2 is performed by the microcomputer 10. A technique for controlling a voltage by switching an input voltage by PWM control is generally used in the field of a switching mode power supply (SMPS) or an inverter and thus, a detailed description thereof will be omitted.

The voltage input/output unit 60 includes a connection terminal T to which the external device is connected, a sensing unit S which measures a voltage and a current of the connection terminal T, and a switching diode units D2 and D3 which switch an input/output direction.

Besides the main elements, as shown on the left of FIG. 1, the apparatus may further include a light-emitting unit 80 including a light-emitting diode (LED) for auxiliary performing a flash function and a switch.

FIG. 2 illustrates the appearance of the apparatus illustrated in FIG. 1. However, the appearance of the present invention is not limited to the appearance of FIG. 2 and FIG. 2 is just an example of a design. A solar cell 20 is positioned on the surface of a body, and a connection terminal T having a side surface to which a connector of a mobile phone as an external device is connected, is installed in FIG. 2. Only one connection terminal T to or from which a voltage is inputted or outputted is installed in FIG. 2. An external battery charger (not shown) to which a voltage should be supplied so as to charge the apparatus as well as an external device such as a mobile phone or an MP3 player to which a voltage should be supplied, may be connected to the common connection terminal T.

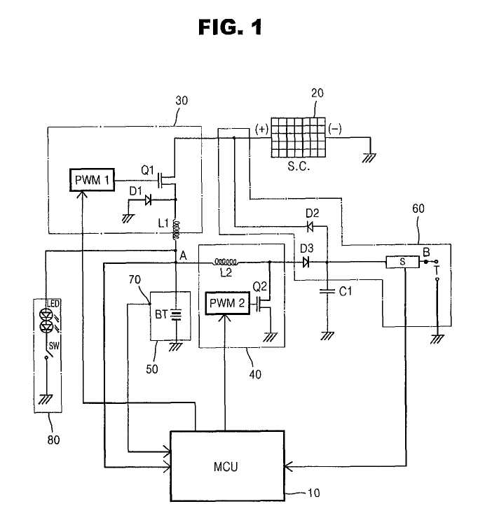

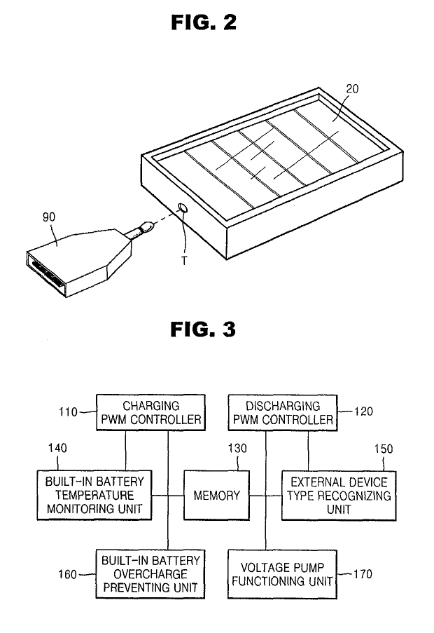

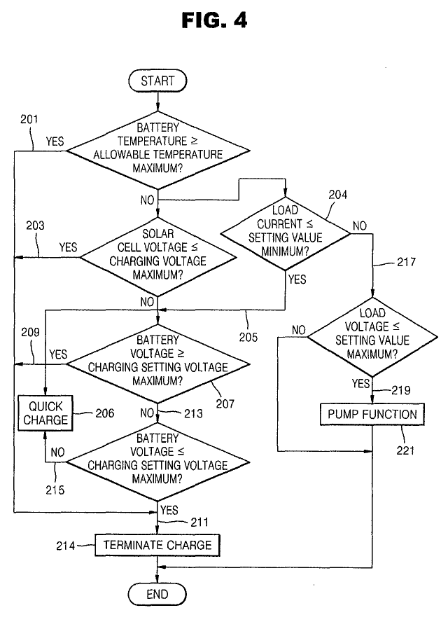

A detailed construction of the microcomputer 10 will be described with reference to FIG. 3. Referring to FIG. 3, the microcomputer 10 includes a built-in battery charging PWM controller 110, a built-in battery discharging PWM controller 120, a built-in battery temperature monitoring unit 140, an external device type recognizing unit 150, a voltage pump functioning unit 170, a built-in battery overcharge preventing unit 160, and a memory 130 in which data needed for functions of the respective elements are stored. The respective elements will now be described in detail with reference to FIG. 4.

Before explaining the detailed operation of the present invention, first, general functions of the respective elements will be described with reference to FIGS. 1 and 3. First, the PWM controller 110 and 120, which concern all functions of the present invention, switch charging and discharging functions of the built-in battery 50 and control charging and discharging voltages through PWM. In the present invention, charging and discharging are alternately performed. That is, only the charging PWM 30 operates in a charging mode in which an external device is not connected to the voltage input/output unit 60 and a power is supplied from the solar cell 20 only to the built-in battery 50, and only the discharging PWM 40 operates in a discharging mode in which the external device is connected to the voltage input/output unit 60 and the power is supplied from the built-in battery 50 to the outside.

The operation of the apparatus according to the present invention will now be described with reference to FIGS. 1 through 4.
1. Overheat Preventing Function of Built-In Battery 50

The function is performed by measuring a voltage, a charging current and a heating temperature of the built-in battery 50, so as to protect the charging apparatus according to the present invention. First, the built-in battery temperature monitoring unit 140 of the microcomputer 10 always monitors the heating temperature of the built-in battery 50 by an output voltage of the temperature sensor 70 attached to the surface of the built-in battery 50 or adjacent thereto. As illustrated in FIG. 4, when the temperature of the built-in battery 50 is equal to or greater than a maximum of an allowable temperature range (operation 201 of FIG. 4), the built-in battery temperature monitoring unit 140 determines that the built-in battery 50 is currently over-charged, allows the built-in battery PWM controller 110 of the microcomputer 10 to stop an operation of the charging PWM 30 so that a power from the solar cell 20 cannot be applied to the built-in battery 50. Since the allowable temperature range of the built-in battery 50 is stored in the memory 130 of the microcomputer 10, the built-in battery temperature monitoring unit 140 just refers to the memory 130.
2. Overcharge Preventing Function of Built-In Battery 50

Overcharge preventing of the built-in battery 50 is performed by constituting the built-in battery overcharge preventing unit 160 so as to more securely protect the charging apparatus according to the present invention other than the above-described overheat preventing function. The built-in battery overcharge preventing unit 160 measures charging voltage and current of the built-in battery 50. The charging voltage is measured as a voltage in the position shown by A of FIG. 1 and the charging current is measured as a current flowing through the position A. In order to measure the charging current, a resistor having a small value (usually, less than several ohms) is connected in series to a path of a current flowing through the built-in battery 50 and a voltage drop at both ends of the resistor is measured. A technique for measuring a current flowing through a specific path is self-obvious to one of ordinary skill in the art and thus will not be specifically described. As a result of measuring the charging voltage and the charging current of the built-in battery 50, when the charging voltage and the charging current are equal to or greater than predetermined reference values (for example, a voltage of the solar cell 20) which have been previously stored in the memory 130 (operation 203 of FIG. 4), the built-in battery overcharge preventing unit 160 determines that the built-in battery 50 is currently over-charged and as described previously, allows the built-in battery charging PWM controller 110 of the microcomputer 10 to stop an operation of the charging PWM 30 so that a current cannot be supplied to the built-in battery 50 any more, thereby protecting the built-in battery 50.
3. Quick Charge Function According to External Devices

The external device type recognizing unit 150 of the microcomputer 10 can automatically recognize a charging voltage and a charging current needed in a battery used in an external device automatically and currently engaged in the voltage input/output unit 60 even though a user does not set an external device type recognition function (that is, an external device type recognition function). For example, since charging circuits inside the mobile phone are different according to types of mobile phones produced in many countries, it is not easy to fully and effectively charge a battery inside various mobile phones using a predetermined charging method. Thus, the external device type recognizing unit 150 of the microcomputer 10 measures a voltage, a current and an impedance of the external device battery engaged in the connection terminal T, thereby. recognizing the type of the external device. For example, a voltage/current specification of the battery is stored in the memory 130 according to types of external devices, the type of the external device currently engaged in the connection terminal T using the voltage and the current of the external device battery measured by the external device type recognizing unit 150, and a voltage and a current suitable for the type are just discharged.

In this regard, since the charging apparatus according to the present invention provides an output voltage in an optimum state in correspondence with all external device types, a full charge or quick charge effect can be obtained in any type of an external device. An operation of performing a quick charge after type recognition is automatically performed in this way will now be described in detail.

First, referring to FIG. 4, as a result of comparing a load current with a setting range (operation 204), if the load current is equal to or less than a minimum of a predetermined value (operation 205), a quick charge is naturally performed from the built-in battery 50 to the external device using a potential difference (operation 206). As a result of comparing a charging setting voltage suitable for the battery of the external device recognized by the external device type recognizing unit 150 with a voltage of a current external device battery (hereinafter, referred to as a battery voltage) (operation 207), if the battery voltage is equal to or greater than a maximum of the charging setting voltage range (operation 209) or if the battery voltage is equal to or less than a minimum of the charging setting voltage range (operation 211), there is no necessity for charging, and the charging operation is terminated (operation 213). And, if the battery voltage is smaller than the maximum of the charging setting voltage range (operation 213) and is larger than the minimum of the charging setting voltage range (operation 215), the charging setting voltage is supplied from the built-in battery 50 to the external device battery so that the quick charge can be performed (operation 206).
4. Voltage Pump Function

In the voltage pump functioning unit 170 of FIG. 3, a voltage pump function means, to the letter, the function of pumping a voltage from a source (that is, the built-in battery 50 being built in the charging apparatus of the present invention) to a destination (that is, an external device such as a mobile phone). Functionally, in the battery inside the external device, due to its characteristic, even when a discharge occurs and a voltage is reduced, a voltage level is temporarily recovered to an original level according to the amount of a residual current of the battery after a predetermined amount of time. In this case, since a potential difference between the source and the destination is not generated in the prior art, a voltage is not supplied to the external device from the built-in battery of the charging apparatus. In the present invention, this case is automatically sensed and a voltage of the source (that is, a discharge voltage of the built-in battery 50) is automatically boosted, a potential difference between the source and the external device is produced so that a voltage can be continuously supplied to the external device from the built-in battery 50 of the charging apparatus.

To this end, a current and a voltage (a load current and a load voltage) of a load (that is, an external device) currently connected from the sending unit S of the voltage input/output unit 60 are measured. As illustrated in FIG. 1, the load voltage can be measured by reading a voltage in the position shown by B of the voltage input/output unit 60 and the load current can be measured by the sensing unit S. As described previously, the sensing unit S may be constituted by connecting a resistor having a small value (usually, equal to or less than several ohms) in series to a current path of the voltage input/output unit 60. A voltage drop value applied to both ends of the resistor is measured so that a current value flowing through the resistor can be known and a terminal current, a voltage and an impedance of the external device can be known.

When the measured load current is compared with a set current range (operation 204 of FIG. 4), if the load current is greater than a minimum of the set current range (operation 217) and the measured load voltage is equal to or less than a maximum of a set voltage range (operation 209), the voltage pump function is performed (operation 221). That is, the voltage pump functioning unit 170 of the microcomputer 10 allows the built-in battery discharging PWM controller 120 to control the discharging PWM 40 to boost a voltage outputted from the voltage input/output unit 60. In the case of PWM, an output level is changed according to a variation in a pulse width. Thus, it may be easily made by one of ordinary skilled in the art that a switching period of the switching element Q2 is changed and a discharging voltage is boosted.

In this way, since the discharging voltage of the built-in battery 50 is higher than a voltage of the load (that is, an external device) connected to the voltage input/output unit 60, a power generated in the built-in battery 50 can be automatically pumped to the external device.
5. Built-In Battery Charging by Voltage Supply from External Battery Charger

Even when the built-in battery 50 is charged from an external battery charger, which is one of the objectives of the present invention, the user just connects a voltage output plug of the external battery charger to the voltage input/output unit 60. Referring to FIG. 1, when a discharge is performed from the built-in battery 50 to the outside, a voltage is outputted to the external device via the connection terminal T through a switching diode D3 of the voltage input/output unit 60 connected in a forward direction. On the other hands, when a voltage is supplied from the external battery charger to the built-in battery 50 via the connection terminal T, the switching diode D3 of the voltage input/output unit 60 is in a reverse direction. Thus, an input voltage is connected to the charging PWM 30 through a switching diode D2 connected in the forward direction and a charging voltage is supplied to the built-in battery 50 instead of the solar cell 20. In this case, the microcomputer 10 can sense that a current flow of the sensing unit S is changed into the reverse direction, the microcomputer 10 allows the built-in battery charging PWM controller 110 to properly control the charging PWM 30 so that a charging operation into the built-in battery 50 can be optimally controlled according to the voltage and current supplied from the external battery charger.
6. Emergency Lamp Function

As an additional function, by adding the light-emitting unit 80 illustrated in FIG. 1, the light-emitting unit 80 can serve as an emergency lamp or a flash lamp in which the built-in battery 50 is used as a power source. The light-emitting unit 80 may be an LED having very small power consumption and a switch for switching on or off the LED may be added to the light-emitting unit 80. A current mobile phone is generalized and is a life necessity which everyone carries. The mobile phone can be always charged while the solar cell charging apparatus of the present invention being carried together -with the mobile phone, and an emergency lamp function is added thereto so that an emergency can be overcome. The life span of the LED is semi-permanent and if only a power is prepared, an inherent function of the LED can be performed anytime.

### INDUSTRIAL APPLICABILITY

According to the present invention, since portable devices are charged by electricity obtained from a solar light, the portable devices can be used while being charged anywhere, any time. In addition, overheating and overcharge states are artificially sensed such that stability is improved, types of artificially-connected external devices are recognized such that optimum and quick charge is performed, and states of the external devices are automatically sensed by the voltage pump function so that a full charge can be performed. A solar light or other external lights are weak so that a built-in battery cannot be charged or if necessary, the built-in battery can be charged from an external battery charger. Even in this case, since only a common input/output connection terminal is used, the construction of the apparatus according to the present invention is simplified, a user is not confused and the apparatus can be conveniently used. In addition, since the charging apparatus of the present invention itself may be one brilliant portable device, an emergency lamp function or a variety of functions useful in life can be easily added.

While this invention has been particularly shown and described with reference to an exemplary embodiment thereof, it will be understood by those skilled in the art that various changes in form and details may be made therein without departing from the spirit and scope of the invention.

What is claimed is:

1. An apparatus for charging portable devices using a solar cell, the apparatus charging a power generated in the solar cell into a battery inside an external device, the apparatus comprising:
a microcomputer;
a built-in battery charging the power generated in the solar cell;
a built-in battery charging pulse width modulation (PWM) unit switching a charging operation into the built-in battery from the solar cell and controlling the magnitude of a voltage (a charge voltage) supplied to the built-in battery;
a built-in battery discharging PWM unit switching a discharging operation in which the voltage charged in the built-in battery is discharged into the external device and controlling the magnitude of a discharge voltage;
a temperature sensor sensing a temperature of the built-in battery; and
a voltage input/output unit outputting the voltage discharged from the built-in battery to the external device and having a common connection terminal to which a voltage is inputted from the outside, so as to supply an output voltage of an external battery charger to the built-in battery.

2. The apparatus of claim 1, wherein the microcomputer comprises:
a built-in battery charging PWM controller controlling the built-in battery charging PWM unit by transmitting a PWM signal to the built-in battery charging PWM unit;
a built-in battery discharging PWM controller controlling the built-in battery discharging PWM unit by transmitting a PWM signal to the built-in battery discharging PWM unit; and
a battery temperature monitoring unit allowing the built-in battery 30 charging PWM unit to stop an operation of the built-in battery charging PWM unit when a temperature of the battery sensed by the temperature sensor is substantially higher than an allowable temperature range.

3. The apparatus of claim 1, wherein the microcomputer comprises:
a built-in battery charging PWM controller controlling the built-in battery charging PWM unit by transmitting a PWM signal to the built-in battery charging PWM unit;
a built-in battery discharging PWM controller controlling the built-in battery discharging PWM unit by transmitting a PWM signal to the built-in battery discharging PWM unit; and
a built-in battery overcharge preventing unit allowing the built-in battery charging PWM unit to stop an operation of the built-in battery charging PWM unit when measured charge voltage and measured charge current of the built-in battery are substantially larger than predetermined reference values.

4. The apparatus of claim 1, wherein the microcomputer comprises:
a built-in battery charging PWM controller controlling the built-in battery charging PWM unit by transmitting a PWM signal to the built-in battery charging PWM unit;
a built-in battery discharging PWM controller controlling the built-in battery discharging PWM unit by transmitting a PWM signal to the built-in battery discharging PWM unit; and
an external device type recognizing unit allowing the built-in battery discharging PWM controller so that the built-in battery discharging PWM unit varies a voltage, by measuring a voltage, a current and an impedance of an external device battery engaged in the connection terminal of the voltage input/output unit and by calculating a discharge voltage and a discharge current suitable for the measured voltage and current of the external device battery.

5. The apparatus of claim 1, wherein the microcomputer comprises:
a built-in battery charging PWM controller controlling the built-in battery charging PWM unit by transmitting a PWM signal to the built-in battery charging PWM unit;
a built-in battery discharging PWM controller controlling the built-in battery discharging PWM unit by transmitting a PWM signal to the built-in battery discharging PWM unit; and
a voltage pump functioning unit allowing the built-in battery discharging PWM controller to control the built-in battery discharging PWM unit and to boost a voltage outputted from the voltage input/output unit when a current and a voltage of a load connected to the connection terminal of the voltage input/output unit are measured and the load current is larger than a minimum of a predetermined value and the load voltage is equal to or less than a maximum of a predetermined voltage range.

6. The apparatus of claim 1, wherein the voltage input/output unit comprises:
a first switching member forming a path on which the voltage discharged from the built-in battery is outputted to the outside via the connection terminal; and
a second switching member forming a path on which the voltage outputted from the external battery charger is inputted via the connection terminal and the built-in battery is charged by the input voltage.

7. The apparatus of claim 1, further comprising:
a light-emitting source emitting light by the discharge voltage of the built-in battery; and
a light-emitting unit including a switch for switching on or off the light-emitting source.
